(19) United States
(12) Patent Application Publication
(10) Pub. No.: US 2024/0069495 A1
(43) Pub. Date: Feb. 29, 2024

(54) WATCH WITH LIGHT SENSOR AND ANTENNA

(71) Applicant: The Swatch Group Research and Development Ltd, Marin (CH)

(72) Inventors: Jean-Jacques BORN, Morges (CH); Gian Carlo POLI, Les Geneveys-sur-Coffrane (CH)

(73) Assignee: The Swatch Group Research and Development Ltd, Marin (CH)

(21) Appl. No.: 18/356,561

(22) Filed: Jul. 21, 2023

(30) Foreign Application Priority Data
Aug. 31, 2022 (EP) 22193119.9

(51) Int. Cl. G04C 10/02; G04B 19/12; H01Q 1/27

(52) U.S. Cl. CPC G04C 10/02; G04B 19/12; H01Q 1/27

(57) ABSTRACT

A watch incorporating an assembly (70) including a light sensor (72), including a photovoltaic cell, a negative electrode (78) and a positive electrode (79). The assembly has a first portion (52A), in which the electrodes are arranged, and a second portion (54A) which is not included in the first portion and which comprises or covers an antenna (80). The semiconductor material wafer extends into the first and second portions, and all the electrodes are arranged below the semiconductor material wafer. Preferably, this semiconductor material wafer or layer has no conductive doping in the second portion. The wafer, or layer, determines, together with additional layers provided thereon, the homogeneous colour and uniform appearance of the assembly from the side of its upper surface. Also, a dial formed by such an assembly.

### CROSS REFERENCE TO RELATED APPLICATIONS

This application claims priority to European Patent Application No. 22193119.9 filed Aug. 31, 2022, the entire contents of which are incorporated herein by reference.

### TECHNICAL FIELD OF THE INVENTION

The invention relates to the field of watches equipped with a light sensor, formed by at least one photovoltaic cell, to power an electronic device of the watch, and an antenna for communication with at least one system or device external to the watch.

In particular, the watch according to the invention comprises a case incorporating the watch movement and an analog time display, this case being formed by a metallic material.

### TECHNOLOGICAL BACKGROUND

Document JP 2019/060847 describes an electronic watch comprising a case with a top opening, a crystal closing the top opening of the case, a movement, an analog display driven by the movement, and an assembly arranged on the movement and formed by a light sensor (also called a ‘solar sensor’) and a top dial for the analog display. The light sensor consists of a plurality of photovoltaic cells. As shown in FIG. 1, appended to the present description, which shows an embodiment described in the JP document, the assembly 2 comprises a film 4, a light sensor 14 arranged on this film, which thus forms a support for the light sensor, and an upper dial 16, distinct from the light sensor, which lets light pass for the light sensor so that this light sensor is visible to a user observing the assembly 2 through the crystal of the watch. In particular, the upper dial 16 carries a graduation for displaying the time. The photovoltaic cells of the light sensor are each formed by the stacking of a metal electrode 6, a layer of semiconductor material 8, a transparent electrode 10 arranged above the semiconductor layer and a protective layer 12. The watch further comprises an antenna 20 arranged to communicate through the crystal of this watch with a communication device external to the watch.

The assembly 2 has a first portion 22, in which the metal electrodes and the transparent electrodes are arranged, and a second portion 24 which is, in projection in a general plane of the assembly (perpendicular to the central axis of the hole 18 provided for the passage of the axes of the analog time display), distinct from the first portion 22 and which covers the antenna 20. The semiconductor material layer 8 extends into the first portion 22 and also into the second portion 24 of the assembly 2, and this layer partly determines the colour of the assembly 2 for a user observing this assembly through the crystal. In the absence of the addition of a non-conductive layer 26, which is provided as a solution in the Japanese document described here, the presence of upper transparent electrodes poses a visual problem since it generates a variation in colour, in particular a variation in hue due to a variation in light reflection, between the first portion 22 and the second portion 24. To solve this problem, a non-conductive layer 26 is added to the second portion 24, which is selected to adjust the light transmission, and thus the reflection at the interface between this layer and the protective layer 12, so that this transmission corresponds substantially to that of the transparent electrode 10.

Such a solution requires the deposition of an additional layer, and it is difficult, if not virtually impossible, to obtain exactly the same hue for both portions 22 and 24. Afterwards, the junction line between the additional layer 26 and the upper transparent electrodes 10 is visible. In addition, as the light sensor 14 comprises a plurality of photovoltaic cells whose upper transparent electrodes 10 define separate sectors, as shown in the figures of the considered JP document, the areas between the transparent electrodes remain visible, so that a user of the watch, observing the dial, distinguishes the photovoltaic cells thanks to a difference in hue between the transparent upper electrodes 10 and the separating areas between them which do not have the conductive material forming the transparent electrodes. Thus, the fact that a light sensor is arranged under the dial 16 remains visible in the embodiment described here. This fact still gives rise to a certain aesthetic problem, so that the solution considered in the Japanese document is partial and therefore does not entirely solve the aesthetic problem associated with the presence of a light sensor under the dial. Indeed, particularly for watches with analog time display, it is generally appreciated that the dial has a uniform colour (exceptions made in particular for useful or decorative prints). A variation in colour between two regions of the dial, due to the arrangement of various technical portions, often confers on the watch a “low-end” appearance. In addition, in particular for classic watches, it might be desired to conceal the presence of photovoltaic cells as much as possible.

### SUMMARY OF THE INVENTION

The present invention aims to solve the above-mentioned aesthetic problem for a watch incorporating a light sensor under an analog display, which is covered by a crystal (also called a glass), and comprising a communication antenna which must be able to communicate with the outside world through the crystal. A principal objective of the invention is to provide such a watch in which the presence of at least one photovoltaic cell at the dial cannot be detected through the crystal by a user of the watch. The invention also aims to provide a classic-looking watch with a dial that appears opaque and with a relatively dark hue.

To this end, the present invention relates to a watch comprising a case having an upper opening, a crystal closing this upper opening, a movement, an analog display driven by the movement, an assembly located between the movement and the analog display and comprising a light sensor, which is formed by a semiconductor material wafer or layer, at least one negative electrode and at least one positive electrode. The watch incorporates an antenna arranged to be able to communicate through the crystal with a communication device external to the watch. Said assembly has a first portion, in which are arranged entirely said at least one positive electrode and said at least one negative electrode, and a second portion without electrodes which is separated from the first portion and a projection of which in a general plane of said assembly includes a projection of the antenna in this general plane. The semiconductor material wafer or layer extends, parallel to the general plane, into the first portion and the second portion of said assembly. Said at least one negative electrode and said at least one positive electrode are all located below the semiconductor material wafer or layer.

Thus, the semiconductor material wafer or layer, in particular of silicon, extends into the first region of the aforementioned assembly, where the photovoltaic light sensor is located, and into the second region of this assembly, which comprises or covers the antenna. In addition, all electrodes are arranged below the semiconductor material wafer or layer. Thanks to this feature, the first region and the second region of the assembly can present exactly the same colour, for a user observing the assembly through the crystal, and do not present any junction line or transition area between these two regions. In addition, since no electrodes are arranged on the semiconductor wafer or layer, it is not possible to visually detect the presence of a light sensor and in particular to discern the structure of such a sensor comprising several photovoltaic cells. Preferably, the semiconductor material wafer or layer extends throughout the first portion and the second portion of said assembly. In an advantageous variant allowing obtaining a dial entirely of the same colour and having a uniform appearance, the semiconductor material wafer or layer extends throughout the visible portion of the assembly for a user observing this assembly through the crystal. Afterwards, preferably, the semiconductor material wafer or layer has a top surface having a uniform specific treatment, in particular texturing or micro-structuring. In addition, one or more additional layers provided above the semiconductor material wafer or layer are advantageously homogeneous and cover the entire assembly. Finally, the top surface of the assembly may have a specific finish, at least in some areas, and in particular the same finish over the entire top surface. By “same colour”, it should be understood the basic colour/hue of the dial, which is homogeneous, so exceptions are made in particular for useful or decorative imprints, appliques on the dial or elements inserted in the dial.

The invention also relates to a dial, for a watch having an analog display, comprising a light sensor which is formed by a semiconductor material wafer or layer, at least one negative electrode and at least one positive electrode, this dial having a first portion, in which said at least one negative electrode and said at least one positive electrode are arranged entirely, and a second portion which is, in projection in a general plane of the dial, separated from the first portion and which is intended for the passage of electromagnetic signals through the dial. The semiconductor material wafer or layer extends parallel to said general plane in the first portion and the second portion of the dial, said at least one negative electrode and said at least one positive electrode all being located below the semiconductor material wafer or layer.

In an advantageous embodiment, the second portion of the dial comprises the antenna, which is arranged below the semiconductor material wafer or layer, this antenna being preferably deposited over the same layer as the electrodes of the light sensor.

### BRIEF DESCRIPTION OF THE FIGURES

The invention will be described in greater detail below with the aid of the appended drawings, given as non-limiting examples, in which:

FIG. 1, already described, shows an assembly, according to the prior art, which comprises a dial for a watch and a photovoltaic light sensor, as well as an antenna arranged in the watch under the assembly shown;

FIG. 2 shows, in simplified form, a first embodiment of a watch according to the invention comprising a first assembly according to the invention and an antenna, the first assembly forming a dial which incorporates a photovoltaic light sensor;

FIG. 3 is a sectional view of a second assembly according to the invention, intended for incorporation in a second embodiment of a watch according to the invention; and

FIG. 4 is a sectional view of a particular variant of the second assembly in FIG. 3, according to a sectional plane at the electrodes of the photovoltaic light sensor.

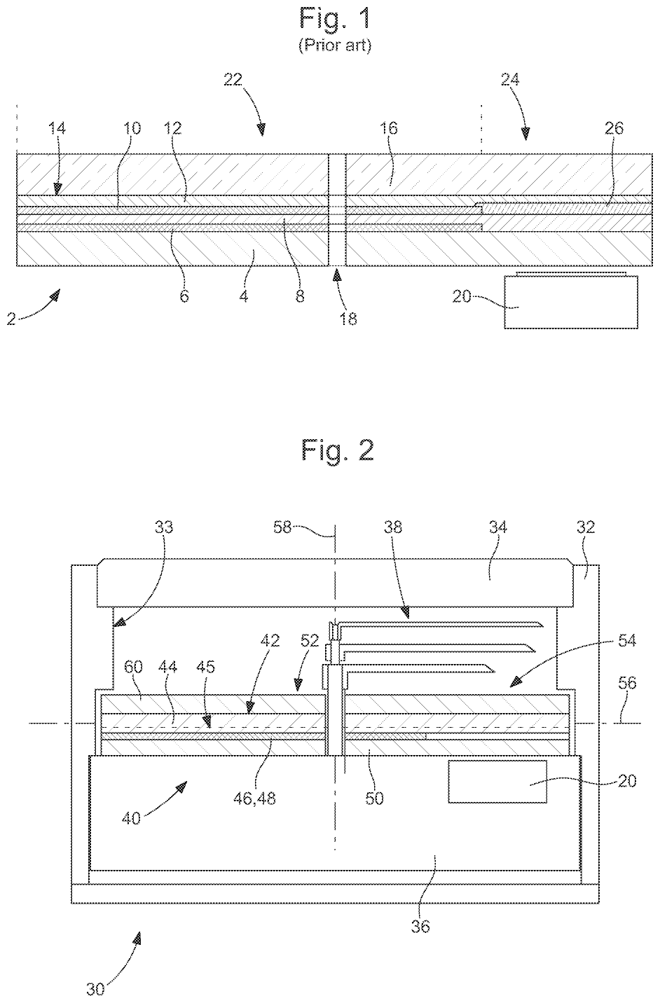

### DETAILED DESCRIPTION OF THE INVENTION

With reference to FIG. 2, a first embodiment of a watch according to the invention is described below.

The watch 30 comprises a case 32 with a top opening 33, a crystal 34 closing the top opening, a movement 36, an analog display 38 driven by the movement, and an assembly 40 which is located generally between the movement and the analog display and which advantageously itself forms the dial of the watch associated with the analog display, no cover plate for the assembly 40 being provided between this assembly and the analog display. The assembly 40 comprises a light sensor 42 including at least one photovoltaic cell and formed by a semiconductor material wafer or layer 44 (also known as a semiconductor material wafer or layer), at least one negative electrode 46 and at least one positive electrode 48, all located below the semiconductor material wafer or layer. In the variants of the invention that are shown, the assembly comprises or is fastened to a support 50 (depending on whether or not this support is considered part of the assembly), in particular by gluing. The semiconductor material wafer or layer 44 is preferably a silicon (Si) wafer or layer.

In the first embodiment, the semiconductor wafer or layer 44 has a lower region 45 which is doped to form areas facilitating the conduction of electrical charges to said at least one negative electrode and said at least one positive electrode with which they are associated (a negatively doped area, called n-type or N-type, is connected to a negative electrode, while a positively doped area, called p-type or P-type, is connected to a positive electrode). By ‘doped region/area’, it should be understood a region/area with electrical conduction that is not very low, or even virtually zero (as is generally the case for low n, N doping or low p, P doping). Thus, a doped area is either an N+ area or a P+ area, or an N++ area or a P++ area, according to standard notations in the semiconductors industry. To clearly indicate that an area is sufficiently doped to exhibit significant electrical conduction, the term ‘conductive doped area’ is used. In the first embodiment, the semiconductor material wafer or layer 44 has conductive doped areas all over its lower portion.

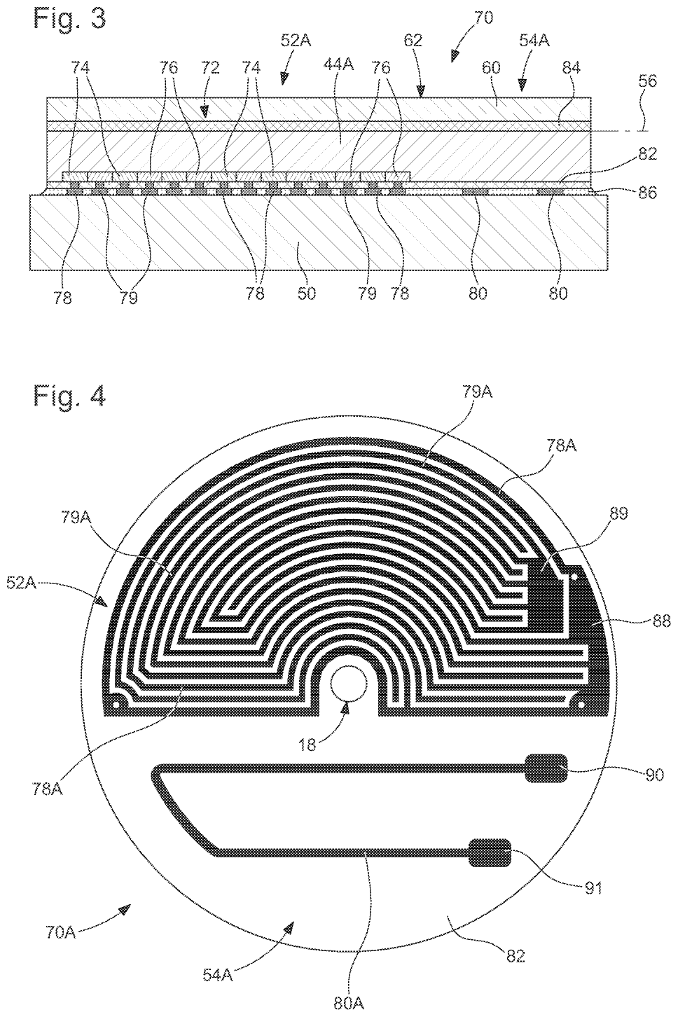

The watch further comprises an antenna 20 arranged to be able to communicate through the crystal 34 with a communication device (not shown) which is external to the watch. The assembly 40 has a first portion 52, in which are arranged entirely said at least one negative electrode 46 and said at least one positive electrode 48 and in which is thus arranged the light sensor 42, and a second portion 54 without electrodes which is separated from the first portion and a projection of which in the general plane 56 of said assembly (this general plane being perpendicular to the axis of rotation 58 of the hands forming the analog display 38) includes a projection of the antenna 20 in this general plane. Thus, the light sensor does not prevent the antenna from communicating with a communication device whose electromagnetic signals enter the watch through the crystal 34, as the antenna and the light sensor are arranged, in projection in the general plane of the assembly 40, in separate areas. For a user of the watch not to be able to distinguish between the first portion and the second portion of the assembly 40 forming the dial, the semiconductor material wafer or layer 44 extends, parallel to the general plane 56, into the first portion 52 of the assembly 40, to form the light sensor 42, and also into the second portion 54 of this assembly. In addition, according to the invention, all of the electrodes of the light sensor are located below the semiconductor wafer or layer 44. Thus, as one could notice in FIG. 2 (and also in FIG. 3 for the second embodiment), the arrangement of the light sensor 42 does not give rise to any particular treatment of the top surface of the semiconductor material wafer or layer 44, nor to any deposition of material on this top surface, which is uniform and presents a homogeneous opaque appearance to an observer. Thus, the observer cannot distinguish the presence of the light sensor by the presence of a structured top layer, in particular transparent top electrodes, as in the prior art.

The semiconductor wafer or layer extends continuously from the first portion 52 to the second portion 54 and forms a single semiconductor wafer or layer that extends at least partially into these first and second portions or, preferably, over the entire region of the assembly 40 that is visible to a user of the watch observing this assembly, forming a dial, through the crystal 34. This last preferred variant allows obtaining a dial with a homogeneous hue and having the same uniform appearance for the user observing this assembly through the crystal. In particular, the semiconductor material wafer or layer extends throughout the first portion 52 and the second portion 54 of the assembly 40, i.e. throughout the entire region of the light sensor 42 and the entire region superimposed on the antenna 20.

According to an advantageous variant, the assembly 40 further comprises at least one layer 60 which is transparent, semi-transparent or translucent and which is arranged above the semiconductor wafer or layer 44. Preferably, the layer 60 is homogeneous and extends over the entire visible portion of the assembly 40, forming the dial of the watch 30, for a user observing this assembly through the crystal 34. In particular, this layer 60 forms a top layer of the assembly 40 and has a top surface that is uniform, at least in the region visible to a user observing this assembly through the crystal. In particular, the layer 60 is arranged so as to entirely cover the semiconductor wafer or layer. Thus, this layer 60 does not alter the perfect homogeneity of colour and uniformity of appearance of the assembly 40 forming the dial of the watch. The layer 60 is advantageously transparent, possibly with a slight colouration, and determines, together with the semiconductor wafer or layer and any layers deposited on the latter, the colour of the first portion 52 and of the second portion 54 of the assembly 40 for a user observing this assembly through the crystal 34, preferably the entire region of this assembly visible to this user. The transparent, semi-transparent or translucent layer 60 darkens the colour of the semiconductor wafer or layer, in particular it confers on the assembly 40 an anthracite, midnight blue or black colour for a user observing the assembly through the crystal. Thus, the layer 60 darkens the colour of the assembly 40, and confers on it a deep colour with a beautiful effect.

In addition, the top layer 60 determines the condition of the top surface of the assembly 40. Indeed, the top surface of the transparent, semi-transparent or translucent layer 60 may have a finish giving, at least in some areas, a matt, brushed, satin or glossy appearance to the assembly. In one variant, this top surface is brushed linearly or radially all over. In particular, the top layer 60 of the assembly 40 is a transparent varnish layer applied over the semiconductor wafer or layer 44. In addition, the assembly 40 may comprise at least one additional layer above the semiconductor wafer or layer. Such an additional layer may be a film forming a filter, an anti-reflective layer or a transmissive light-scattering layer.

In a particular variant appropriate to the arrangement of the antenna in the watch according to the invention, the case 32 is formed at least for the most part by one or more metallic materials. In a conventional variant, the outer portions of the case 32 are entirely metallic.

With reference to FIGS. 3 and 4, a second embodiment of an assembly forming a dial according to the invention will be described below. Some elements already described in detail above and possible variants will not be described again for the second embodiment, the description focusing primarily on the differences and special features of this second embodiment.

As in the first embodiment, this second embodiment is advantageously characterised by the fact that the positive electrodes and the negative electrodes are arranged under the semiconductor material wafer or layer 44A. This second embodiment differs from the first embodiment essentially in that the antenna is included in the assembly or supported by the latter.

FIG. 3 shows an assembly 70 according to the invention, which forms a dial for an analog display watch and which comprises a light sensor 72 formed by at least one photovoltaic cell. In general, the light sensor 72 is formed by a semiconductor material wafer or layer 44A, negative electrodes 78 and positive electrodes 79. The assembly 70 has a first portion 52A, in which the negative electrodes and the positive electrodes are arranged in their entirety, and a second portion 54A which is, in projection in a general plane 56 of the assembly, separated from the first portion. The second portion is intended for the passage of electromagnetic signals originating from a communication device or generated by the antenna 80. The semiconductor material wafer or layer 44A (the semiconductor wafer or layer) extends, parallel to said general plane, into the first portion 52A and the second portion 54A of the assembly 70, which is a dial. The second portion 54A of assembly 70 comprises or supports, on a lower side of this assembly, an antenna 80. To avoid interfering with the proper operation of the antenna 80, the semiconductor material wafer or layer 44A has no conductive doped areas in the second portion of said assembly. It should be noted that the semiconductor material wafer or layer 44A may be weakly doped in part or totally in the second portion 54A of the assembly 70.

The antenna 80 is located below the semiconductor material wafer or layer, so as to be invisible from the side of the top surface 62 of the assembly, which is the visible surface of the dial formed by this assembly 70 once the latter has been incorporated into a watch case to form a watch according to the invention.

In the advantageous variant shown in FIG. 3, the second portion 54A of the assembly 70 comprises the antenna 80, which is arranged below the semiconductor wafer or layer 44A. In particular, the antenna 80 is deposited on the same layer 82 as the electrodes 78 and 79 of the light sensor. The lower layer 82 is a passivation layer for the light sensor 72. In the variant shown in FIG. 3, there is a plurality of negative electrodes 78 and a plurality of positive electrodes 79 arranged alternately, each positive electrode being arranged between two negative electrodes. The plurality of negative electrodes 78 and the plurality of positive electrodes 79 are all deposited inferiorly on the passivation layer 82, which inferiorly covers the semiconductor wafer or layer 44A, and are connected by openings provided in the passivation layer 82 respectively to a plurality of N+ doped lower areas 74 and to a plurality of P+ doped lower areas 76, these doped areas 74, 76 being therefore conductive. In a particular variant, the antenna 80 is made of the same material as the negative electrodes and the positive electrodes.

In the usual way, the semiconductor wafer or layer is conductively doped in various regions of the first portion of the assembly. In contrast, the semiconductor wafer or layer is not conductively doped in the second portion 54A of the assembly. As previously stated, ‘conductively doped’ indicates ‘doped so as to exhibit significant electrical conduction’ and consequently ‘conductively undoped’ means ‘not doped so as to exhibit significant electrical conduction’ or equivalently ‘undoped or doped so as to exhibit insignificant, i.e. very low, electrical conduction’. Thus, in the second region of the assembly, the semiconductor wafer or layer 44 may, in one variant, be weakly doped (i.e. n, N doped or p, P doped in the usual terminology). What's important is that the semiconductor wafer or layer does not create a magnetic screen for the antenna through doping. In other words, we avoid significantly disrupting the transmission of electromagnetic signals between the antenna and an external communication device located on the upper surface side of the assembly 70 and with which it is intended that a watch incorporating this assembly could communicate through the upper crystal of the watch, or generating a significant increase in the intensity of such signals to ensure correct communication.

In a preferred embodiment, the semiconductor material wafer or layer 44A extends throughout the first portion 52A and throughout the second portion 54A of the assembly 70.

In a preferred embodiment, the semiconductor material wafer or layer extends in projection over the entire top surface 62 of the assembly 70.

Preferably, the semiconductor material wafer or layer is textured (micro-structured) over its entire upper surface, and at least one anti-reflective layer 84 is deposited on the semiconductor material wafer or layer, so as to cover it completely. The anti-reflective layer is uniformly deposited on the semiconductor material wafer or layer. The assembly 70 may also include a light-scattering layer. Preferably, all layers deposited on top of the semiconductor wafer or layer 44A are deposited uniformly over the entire semiconductor wafer or layer. The result is an assembly 70 with a perfectly uniform colour and a perfectly uniform appearance on the top surface 62 side. Nonetheless, for aesthetic purposes or to ensure that the dial presents a given pattern, other than that of a photovoltaic cell or antenna, for example a logo, the treatment of at least one top layer may be non-uniform, but deliberately differentiated.

As in the first embodiment, the assembly 70 further comprises a top layer 60 which is transparent or translucent and which, together with the semiconductor material wafer or layer and the anti-reflective layer 84, determines the colour of said first and second portions of the assembly on the side of the top surface 62 of the assembly. It also determines the condition of this upper surface. Preferably, the top layer 60 is transparent and uniformly covers the entire top surface 62 of the assembly 70.

Finally, the assembly 70 is glued on a support 50 by means of a layer of glue 86. As already indicated, this support 50 may or may not be considered as part of the assembly 70. Together with the support 50, the assembly defines a module which forms a solar dial, i.e. equipped with at least one photovoltaic cell, and which also incorporates an antenna.

FIG. 4 shows a section of an assembly 70A, which is a variant of the second embodiment. The section is parallel to the general plane of the assembly 70A at the level of the electrodes of its light sensor. If the support 50 and the glue layer 86 are not included in the assembly or in the case where such a support is not provided, then FIG. 4 is a bottom view of the assembly. A particular feature of this variant is the arrangement of the plurality of negative electrodes 78A and the plurality of positive electrodes 79A, this arrangement allowing optimally occupying a semicircular or truncated-circular portion of a disk having a hole 18 at its centre for the passage of the axes of an analog display. The particular arrangement of the negative and positive electrodes, nested inside one another, also allows having the negative contact pad 88, to which the negative electrodes 78A are connected, and the positive contact pad 89, to which the positive electrodes 79A are connected, next to one another in the same radial area of the assembly 70A, and thus having two adjacent contact pads that are close to one another, which facilitates electrical connection to an electrical connector provided for the light sensor.

The plurality of negative electrodes 78A and the plurality of positive electrodes 79A, the two contact pads 88 and 89 and the antenna 80A are deposited below on the passivation layer 82 described above. Whether we are talking about a plurality of negative electrodes and a plurality of positive electrodes, or a single negative electrode and a single positive electrode each having a plurality of elongated arms, given that all of the arms of the same polarity are connected to the same contact pad, is a matter of definition with no consequence to the present invention.

The antenna 80A is intended for high-frequency communication, this antenna being formed by a single U-shaped track whose two ends are connected respectively to two contact pads 90 and 91 which are also deposited on the passivation layer 82, which in particular defines a rear mirror for the light sensor. The passivation layer extends over the entire semiconductor wafer or layer, which extends, in projection in the general plane of the assembly 70A, over this entire assembly. The light sensor occupies a first portion 52A of the assembly and the antenna occupies a second portion 54A of this assembly, separate from the first portion, these two portions forming the entire assembly 70A. Thus, by “separate”, it should also be understood a case where the two portions are contiguous.

In another variant that is not shown, the second portion of the assembly supports the antenna (a module forming this antenna) on a lower side of this assembly, this antenna being fastened to the assembly for example by gluing.

Finally, it should be noted that the first portion and the second portion may have different shapes, and that the electrodes may be arranged differently. For example, the light sensor may be annular with the antenna arranged at the centre. In this case, the first portion of the assembly forms an annular structure and the second portion of the assembly forms a central disk with a circular hole in its centre. In another variant, the second portion may consist of a substantially rectangular or square portion which extends radially from the circumference of the assembly forming the dial, the first portion of the assembly forming the portion complementary to this radial portion.

1. A watch comprising:
a case having a top opening;
a crystal closing this top opening;
a movement;
an analog display driven by the movement;
an assembly located between the movement and the analog display and comprising a light sensor which is formed by a semiconductor material wafer or layer;
at least one negative electrode and at least one positive electrode; and
an antenna arranged to communicate through the crystal with a communication device external to the watch,
wherein said assembly has a first portion, in which are arranged entirely said at least one positive electrode and said at least one negative electrode, and a second portion (without electrode which is separated from the first portion and a projection of which in a general plane of said assembly includes a projection of the antenna in the general plane,
wherein the semiconductor material wafer or layer extends, parallel to the general plane, into the first portion and the second portion of said assembly, and
wherein said at least one negative electrode and said at least one positive electrode are all located below the semiconductor material wafer or layer.

2. The watch according to claim 1, wherein the semiconductor material wafer or layer has no conductive doped areas in the second portion of said assembly.

3. The watch according to claim 1, wherein the semiconductor material wafer or layer extends throughout the first portion and the second portion of said assembly.

4. The watch according to claim 1, wherein the semiconductor material wafer or layer extends throughout the visible portion of said assembly for a user observing said assembly through the crystal.

5. The watch according to claim 1, wherein the semiconductor material wafer or layer is textured over its entire upper surface; and wherein an anti-reflective layer is deposited above this upper surface.

6. The watch according to claim 1, wherein said assembly comprises a transparent, semi-transparent or translucent layer which is arranged above the semiconductor material wafer or layer, which forms an upper layer of the assembly and which darkens the colour of this assembly, giving it in particular an anthracite, midnight blue or near-black colour.

7. The watch according to claim 6, wherein the upper surface of the transparent, semi-transparent or translucent layer has a finish giving, at least in some areas, a matt, brushed, satin or glossy appearance to said assembly.

8. The watch according to claim 1, wherein said assembly itself forms a dial for the analog display, no cover plate of said assembly being provided between the assembly and the analog display.

9. The watch according to claim 1, wherein the antenna is supported by said assembly on a lower side of this assembly.

10. The watch according to claim 1, wherein the antenna is deposited, on a lower side of the semiconductor material wafer or layer, on a same layer as said at least one positive electrode and said at least one negative electrode.

11. The watch according to claim 1, wherein said case is formed at least for the most part by one or more metallic materials.

12. A dial for a watch having an analog display, comprising a light sensor which is formed by a semiconductor material wafer or layer, at least one negative electrode and at least one positive electrode,
wherein the dial has a first portion, in which said at least one negative electrode and said at least one positive electrode are arranged in their entirety, and a second portion which is, in projection in a general plane of the dial, separated from the first portion and which is provided for the passage of electromagnetic signals through the dial, the semiconductor material wafer or layer extending parallel to said general plane in the first portion and the second portion of the dial, said at least one negative electrode and said at least one positive electrode all being located below the semiconductor material wafer or layer.

13. The dial according to claim 12, wherein the semiconductor material wafer or layer has no conductive doped areas in the second portion of the dial.

14. The dial according to claim 12, wherein the second portion of the dial comprises an antenna, which is arranged below the semiconductor material wafer or layer.

15. The dial according to claim 14, wherein the antenna is deposited on the same layer as said at least one negative electrode and said at least one positive electrode.

16. The dial according to claim 15, wherein the antenna is formed by the same material as said at least one negative electrode and said at least one positive electrode.

17. The dial according to claim 12, wherein the semiconductor material wafer or layer extends in said general plane over the entire dial.

18. The dial according to claim 12, wherein the semiconductor material wafer or layer has a texturing over its entire upper surface.

19. The dial according to claim 12, wherein an anti-reflective layer is uniformly deposited on the semiconductor material wafer or layer.

20. The dial according to claim 12, wherein it comprises at least one transparent, semi-transparent or translucent layer which is arranged above the semiconductor material wafer or layer so as to cover it entirely, and which darkens the colour of the dial, in particular anthracite, midnight blue or near-black.

21. The dial according to claim 20, wherein an upper surface of the transparent, semi-transparent or translucent layer has a finish giving, at least in some areas, a matt, brushed, satin or glossy appearance to the dial.
